(19) United States
(12) Patent Application Publication
(10) Pub. No.: US 2020/0305623 A1
(43) Pub. Date: Oct. 1, 2020

(54) BIODEGRADABLE DRINKING STRAW HAVING BIOPOLYMER ELEMENTS

(71) Applicant: Mark Steele, New Prague, MN (US)

(72) Inventor: Mark Steele, New Prague, MN (US)

(21) Appl. No.: 16/837,994

(22) Filed: Apr. 1, 2020

Related U.S. Application Data
(60) Provisional application No. 62/827,376, filed on Apr. 1, 2019.

(51) Int. Cl. A47G 21/18; B32B 27/36; B32B 3/10; B32B 7/12; B32B 27/12; B32B 1/08

(52) U.S. Cl. CPC A47G 21/18; B32B 27/36; B32B 3/10; B32B 2597/00; B32B 27/12; B32B 1/08; B32B 2250/40; B32B 7/12

(57) ABSTRACT

Drinking straws are provided that can include one or more paper or fiber-based elements or layers and one or more biopolymer elements or layers. Other embodiments can include a drinking straw constructed at least in part of a biopolymer material having a plurality of reinforcement strips or ribs.

### PRIORITY

This application claims priority to and the benefit of U.S. Provisional Patent Application No. 62/827,376, filed Apr. 1, 2019, which is incorporated fully herein by reference.

### FIELD

The present invention relates generally to conduits adapted to facilitate drinking from a vessel and, more particularly, to drinking straws constructed of one or more biopolymer elements.

### BACKGROUND

Plastic straws have become a large nuisance and concern across the world. The types of material currently being used to make these plastic straws is not considered desirably biodegradable as they can take many decades to break down. They have infiltrated rivers, lakes, and oceans, causing great harm to fish, birds, turtles, and other wildlife. For this reason, some states and other government entities have banned plastic straws in order to reduce the number of straws being used, and the issues caused from their use.

In an attempt to find a substitute for plastic straws, there has been a push to go back to paper straws. Paper straws break down and degrade after a relatively short period of time, which reduces the negative environmental impact of straw usage and disposal.

However, paper straws simply do not work very well. Paper straws can have an undesirable taste, and upon being submerged in a liquid for even a short period of time, they become soft and mushy. Coating the paper can help, but the coating process can add significant and undesirable cost, as well as possibly keep the paper from breaking down as quickly after being used and discarded.

As a result, there is a need for a drinking straw that substantially solves the above-referenced problems.

### SUMMARY

Embodiments of the present invention can include multi-layered drinking straws having one or more fiber-based substrates or elements (e.g., paper) and one or more biopolymer elements, including a method of blending at least one biodegradable film structure or other biodegradable or compostable material with paper to construct the straw (e.g., around a paper layer). While the specific layered construct can vary greatly, embodiments can include a center paper reel, an inner biopolymer reel, and an outer biopolymer reel to create the multi-layered and biodegradable straw. It is generally desired for the materials of the straw to break down within 12 months, depending on the environment. However, the target compostable or biodegradable period can vary depending on the application.

Other embodiments can include introducing the biopolymer material as reinforcement strips or ribs running down the length of the straw. The reinforcement ribs can be fed or placed between layers of paper, along materials, or between any layers of the multilayered biopolymer straw. The ribs can also be placed in between a combination of a paper and biopolymer wound straw for extra reinforcement, if needed.

In other embodiments, the biodegradable straw can be constructed of a biopolymer material having a plurality of reinforcement ribs, generally extending longitudinally down the length of the straw.

Various embodiments of the drinking straw can be constructed of multi-wound or multi-layered materials or laminates, wherein some or all of the materials are biopolymer.

Embodiments of the present invention provide a straw that is capable of biodegrading or composting in a desirable period of time. The features and designs of the straws disclosed herein can increase exposure of the biopolymer materials to accelerate the introduction of oxygen and moisture to permit growing and multiplying of microorganisms (e.g., microbes) to facilitate biodegradability.

The above summary is not intended to describe each illustrated embodiment, claimed embodiment or implementation of the invention. The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

The invention may be more completely understood in consideration of the following detailed description of various embodiments of the invention in connection with the accompanying drawings, in which:

FIGS. 1-2 show a biodegradable straw having one or more paper material layers and one or more biopolymer material layers, in accordance with embodiments of the present invention.

FIGS. 3-3a show a biodegradable straw having one or more paper material layers and one or more biopolymer stiffening strips or ribs, in accordance with embodiments of the present invention.

FIGS. 4-4a show an extruded biodegradable straw having one or more reinforcement strips or ribs, in accordance with embodiments of the present invention.

FIGS. 5-5a show an extruded biodegradable straw having one or more reinforcement strips or ribs within a film layer gap, in accordance with embodiments of the present invention.

FIGS. 6-6a show a biodegradable straw having one or more biopolymer material layers and one or more biopolymer or paper stiffening strips or ribs, in accordance with embodiments of the present invention.

FIG. 7 shows the formation of a biodegradable straw having one or more perforations or other like features applied to one or more biopolymer or pre-laminated biopolymer material layers, in accordance with embodiments of the present invention.

FIGS. 8-8a show the formation of a biodegradable straw having one or more pre-laminated materials, in accordance with embodiments of the present invention.

FIGS. 9-9a show the formation of a biodegradable straw having one or laminate materials wrapped linearly around a mandrel, in accordance with embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives falling within the spirit and scope of the invention as defined by the appended claims.

### DETAILED DESCRIPTION OF THE INVENTION

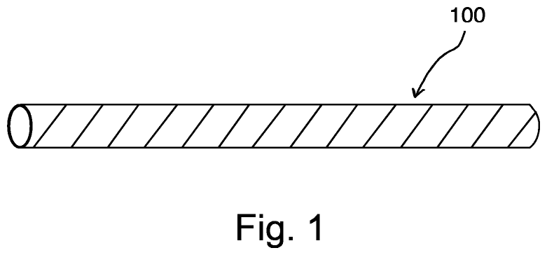

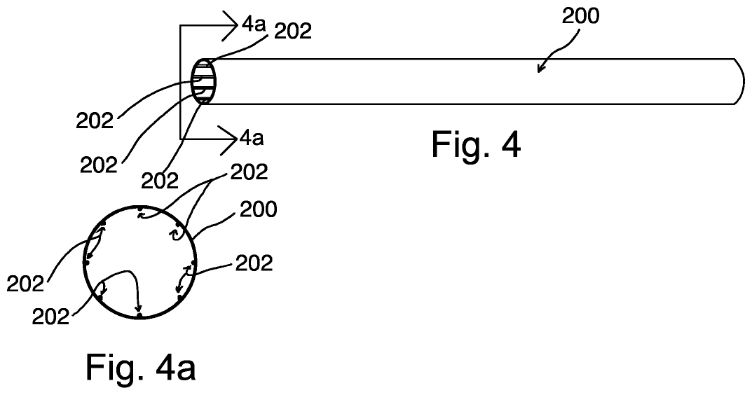

Referring to FIGS. 1-9a, drinking straws in accordance with embodiments of the present invention are shown. FIGS. 1-3a depict multi-layered straw 100 embodiments including one or more paper or fiber-based substrates or elements and one or more biopolymer substrates or elements. FIGS. 4-4a depict an embodiment of an extruded straw 200 constructed of a biopolymer material having a plurality of reinforcement strips or ribs. It is generally desired for the materials of the straw to break down within 12 months, depending on the environment (e.g., home environment, industrial environment, marine environment, etc.). However, the target compostable or biodegradable period can vary depending on the application. Further, Various embodiments of the drinking straw can be constructed of multi-wound or multi-layered materials, wherein some or all of the materials are biopolymer.

There are many new types of biopolymer substrates, some known as Poly-lactic-acid (“PLA”) structures, being continually created and modified. Various other biopolymer materials can be used with embodiments of the present invention, including Poly-hydroxybutyrate (“PHB”), PLA-PHB blends, starch-PLA blends, starch-PCL blends, etc. Many of these new substrates look and feel like some of the typical plastic films currently being used in flexible packaging and other industries. However, the difference with these materials is that they are typically made from renewable energy sources like cornstarch, and are designed to biodegrade—e.g., in compost, after getting wet, after being exposed to UV or sunlight, etc. These substrates can be formulated to break down with salt water, fresh water, or via a multitude of other methods or factors. By themselves, the substrates do not provide all of the benefits of other structures. For instance, the costs associated with extrusion, blown film substrates, or cast film substrates thick enough and consistent enough to serve as a viable straw option may outweigh the benefits. Further, the stiffness of these materials by themselves may not ultimately result in a good, functional straw.

As shown in FIGS. 1-3a, embodiments of the present invention can include a multi-layered straw device 100, and a method of blending or combining at least one biodegradable film structure or material with paper to construct the straw 100. Typically, while making a paper straw, there are three or more reels of paper wound onto an anvil to form the tube. There is an inner layer, a center or core layer, and an outer layer. With each embodiment herein, various adhesives, including co-adhesives or compostable adhesives (e.g., H2O, solventless, solvent-based, etc.) can be used to bind the layers together. Various embodiments of the present invention combine one or more biopolymer materials with at least one paper material to form the biodegradable straw 100.

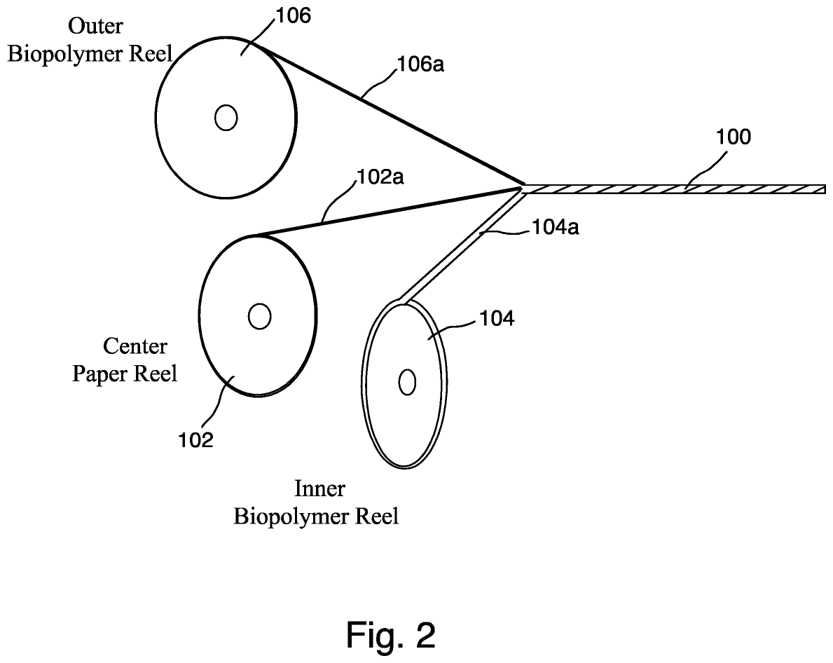

The straw 100 embodiment of FIGS. 1-2 incorporates a biopolymer substrate for one or more of the layers. For example, a center paper reel or roll 102, an inner biopolymer reel or roll 104, and an outer biopolymer reel or roll 106 are fed through formation machinery. As such, an inner biopolymer film material 104a, an outer biopolymer film material 106a, and a center paper material 102a are interwound or layered to create the drinking straw 100, with the paper material 102a constituting the central or core layer. Other combinations of material layers are envisioned as well without deviating from the spirit and scope of the present invention.

The biopolymer materials by themselves, especially if made thin and economical, are not very structurally strong for use as a straw. However, by mixing one or more of these biopolymer layers or materials with one or more layers of paper, the paper can be used as the backbone, or the thicker/stronger portion, while the biopolymer layers can protect the paper from becoming soggy, limp, or otherwise structurally compromised. The combination of structures, each with their own strengths and weaknesses, used together, complement each other and make for a very functional straw 100 that can still break down or biodegrade after it is discarded. Further, the paper layer, over time, can serve as a moisture wick, or wicking element, thereby assisting in breaking down the biopolymer layers at a desirably faster rate. Namely, submerging or otherwise causing the paper layer to get wet, assists in facilitating, and can even speed up, the biodegrading process of the biopolymer film layers, e.g., PLA film.

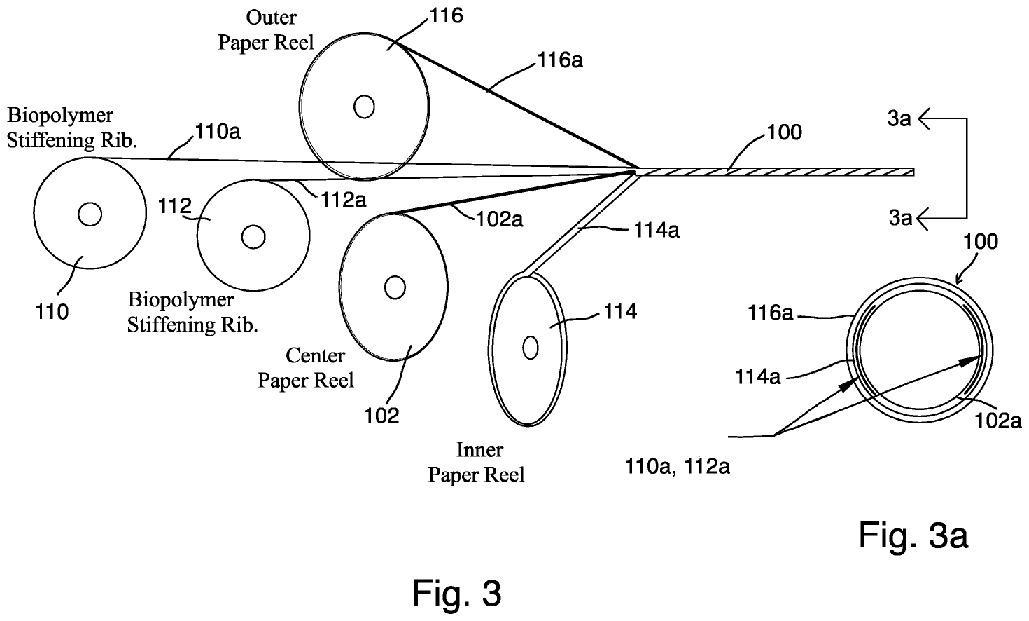

As shown in FIGS. 3-3a, the biopolymer material can also be introduced as one or more reinforcement ribs or strips 110a, 112a running down the length of the straw 100, placed between either layers of paper with a paper straw, or between any layers of the multilayered biopolymer straw. The ribs or strips disclosed herein can be constructed of a biopolymer, paper, and the like. The ribs or strips 110a 112a can also be placed in between a combination paper and biopolymer wound straw for extra reinforcement if desired. Referring to FIG. 3, embodiments of the formation process can include a center paper reel 102 that feeds paper material 102a, an inner paper reel 114 that feeds a second or inner paper material 114a, an outer paper reel 116 that feeds a third or outer paper material 116a, a first biopolymer stiffening rib reel 110 feeding a first biopolymer rib material 110a, and a second biopolymer stiffening rib reel 112 feeding a second biopolymer rib material 112a, to form the multi-material and layered drinking straw 100. The reinforcement ribs 110a, 112a can run generally straight down the longitudinal length of the straw 100 by rotating the rolls 110, 112 of reinforcement material 110a, 112a at the same speed by which the primary straw materials 102, 114, 116 are being wound. In other embodiments, the reinforcement ribs 110a, 112a can be spiral wound between the primary straw material layers 102, 114, 116 by running them linearly down the anvil and not rotating the rib material rolls 110, 112 while the straw material is being wound.

As shown in FIGS. 4-4a, embodiments of the present invention can include an extruded straw 200, constructed at least in part of a biopolymer material. This biopolymer straw 200 can include one or more extruded reinforcement ribs 202 extending along portions of the straw (e.g., along the longitudinal length, transverse, etc.), thereby providing a straw that is both rigid and durable enough to be used as a drinking straw. This would not interfere with the use of the straw, allowing it to be used as intended. The ribs 202 can run down the length of the straw 200, can be helical (spiral wound) down the length, or take on a myriad of other orientations, positioning, shapes, and constructs.

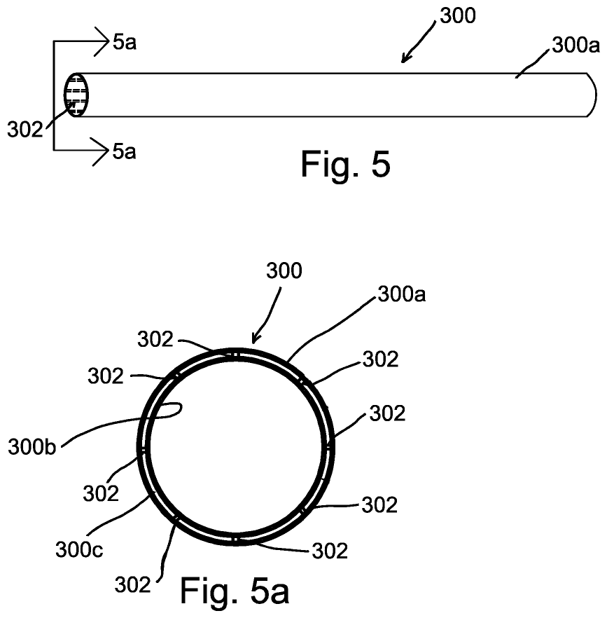

Referring to FIGS. 5-5a, embodiments of the present invention can include an extruded straw 300, constructed at least in part of a biopolymer material. This biopolymer straw 300 can include one or more extruded reinforcement ribs 302 extending along portions of the straw. The ribs 302 can be provided between an outer tube portion 300a and an inner tube portion 300b, within a defined gap region 300c. Again, the ribs 302 can run down the length of the straw 300, can be helical (spiral wound) down the length, or take on a myriad of other orientations, positioning, shapes, and constructs.

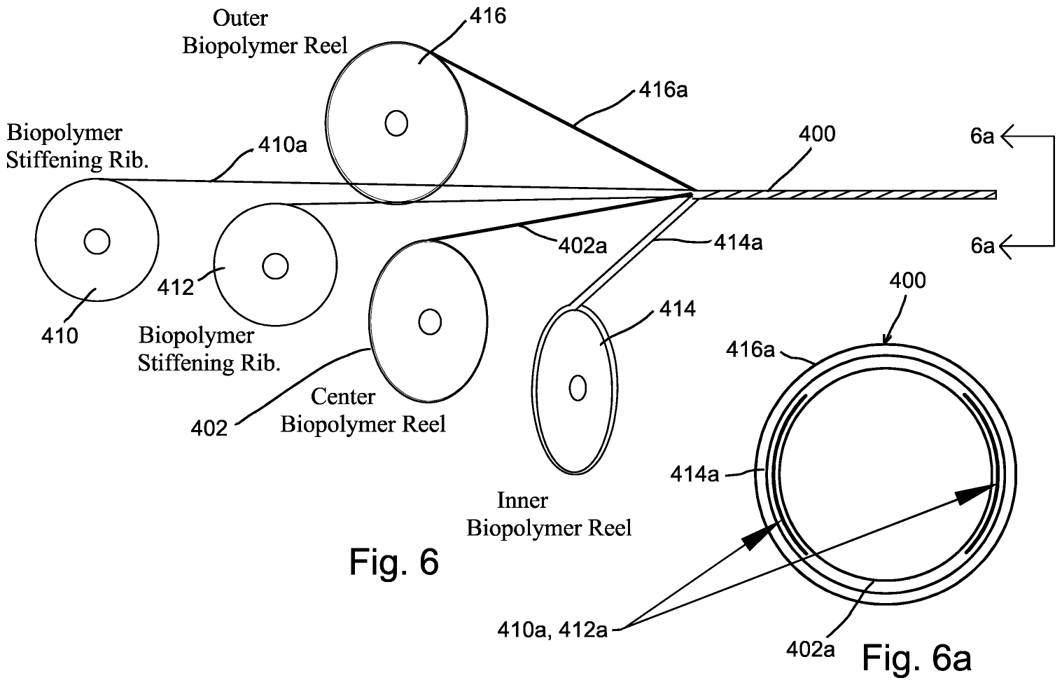

FIGS. 6-6a show embodiments of a straw 400 incorporating a plurality of biopolymer substrates to define one or more layers of the straw 400, and one or more biopolymer or paper stiffening ribs provided within the layers. For example, a center biopolymer reel or roll 402, an inner biopolymer reel or roll 414, and an outer biopolymer reel or roll 416 are fed through formation machinery. Further, a reel or roll 410 can feed in a first stiffening rib 410a, a second reel or roll 412 can feed in a second stiffening rib 412a. One or more ribs are envisioned with various embodiments. With this and other embodiments, the stiffening ribs can be constructed of a biopolymer material, a paper material, and the like.

An inner biopolymer film material 414a, an outer biopolymer film material 416, and a center biopolymer film material 402a are interwound or layered to create the drinking straw 400 with the stiffening ribs 410a, 412a provided within at least two of the layers. In various embodiments, one or more of the ribs can be included in alternating or separate layers of the biopolymers. Other combinations of material layers and material constructs are envisioned as well without deviating from the spirit and scope of the present invention.

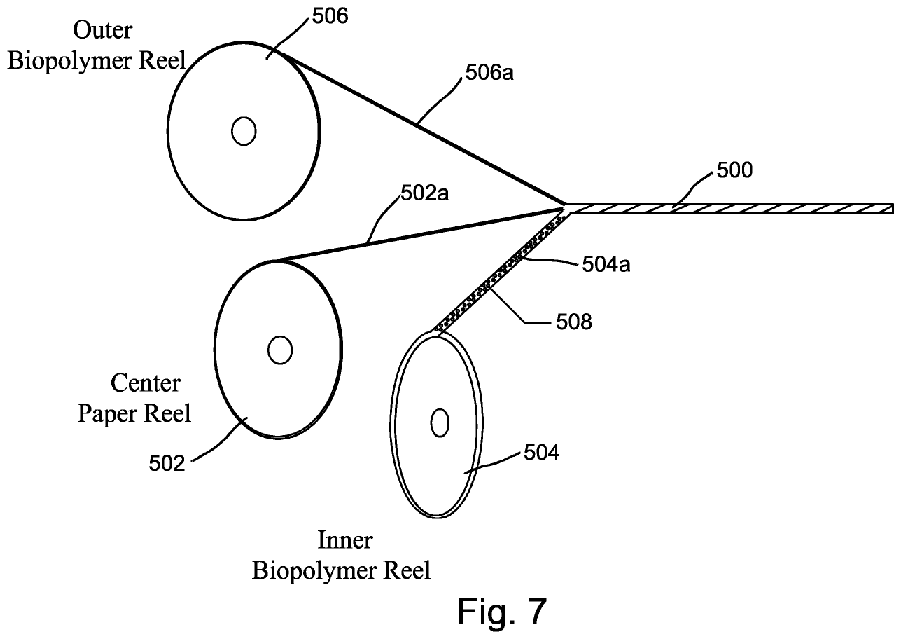

As shown in FIG. 7, a straw 500 is formed or defined with one or more biopolymer film layers 506a, one or more paper layers 502a, and perforation or other like elements provided along one or more of the biopolymer layers. For instance, embodiments can include an inner biopolymer reel 504 that feeds an inner biopolymer film layer 504a, an outer biopolymer reel 506 that feeds an outer biopolymer film layer 506a, and a central paper reel 502 that feeds a paper layer 502a to form the straw 500. One or more of the layers, e.g., the inner biopolymer film 504a, can include perforations, holes, laser cuts, slits, and like features or deformations provided with one or more of the straw layers to promote liquid wicking desirable to facilitate biodegradability. By selectively applying the perforations and other features to one or more straw layers, it is possible to target the wicking benefits without relying on wicking along the entire length of the straw, e.g., from end to end.

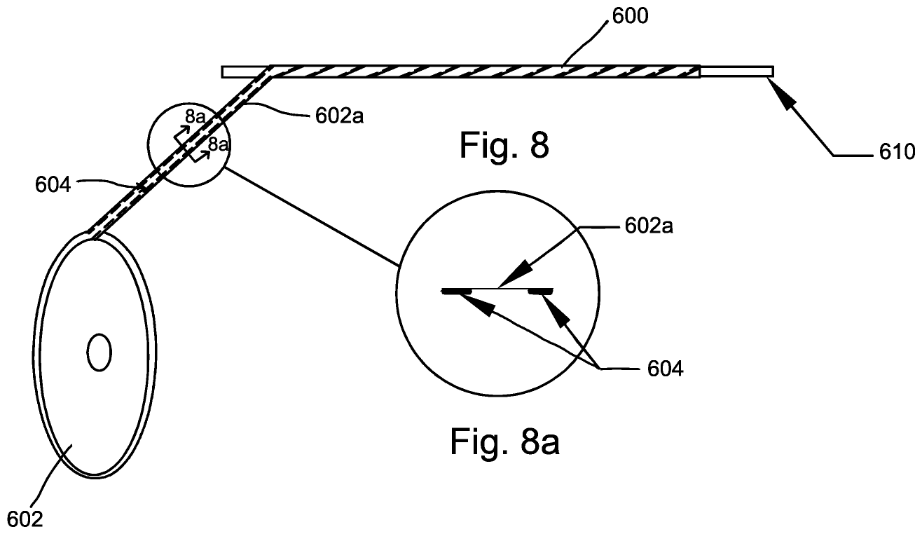

FIGS. 8-8a show embodiments of the present invention including pre-laminated or formed multi-layer film materials to construct a straw 600. For example, the pre-laminated or multi-layer film 602a can be provided on a single master roll 602 and wound over (or wrapped linearly around) a mandrel 610 or like device or process to form the straw 600. Such a process enables formation with a single wrap or roll. With this and other embodiments, one or more areas of the straw 600 can include one or more adhering elements 604, such as an adhesive, a co-adhesive (e.g., compostable adhesives such as H2O, solventless, solvent-based, etc.), and the like. The one or more adhering elements 604 can be included on one or more of the sides of the multi-layered laminate film 602. The adhering elements 604 can be applied along edges or ends of the laminate film 602 (e.g., FIG. 8a), along the entirety of the film 602 surface as a coating, or at specifically targeted locations.

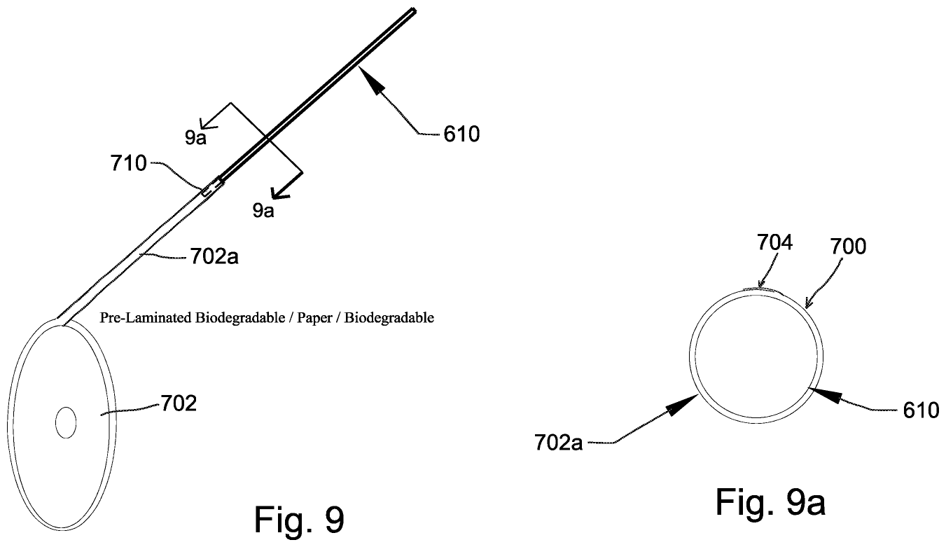

FIGS. 9-9a show embodiments of the present invention including pre-laminated or formed multi-layer film materials to construct a straw 700. For example, the pre-laminated or multi-layer film 702a can be provided on a single master roll 702 and wrapped linearly around (or wound on) the mandrel 610 or like device or process to form the straw 700. Such a process enables formation with a single wrap or roll. With this and other embodiments, a joining region 704 can facilitate joining, along the straw length, the inside and outside layer of the material 702a that is wrapped linearly around the mandrel 610, e.g., via heat sealing, adhering, etc., to provide the tubular shape of the straw 700. When wrapped linearly around the mandrel, 610, the material 702a edges can be overlapped and sealed along their edges by means of an adhesive or co-adhesive. When the inner and outer layers of the material 702a are constructed of a biopolymer material, the edges can be heat sealed together.

While various embodiments disclose paper/fiber-based layers sandwiched between biopolymer layers, other embodiments of the present invention can include two or more layers of biopolymer material without a paper layer, one or more biopolymer layers and one or more paper layers, and other variations on the number of layers and the material construct of each layer.

It is noted that any of the embodiments disclosed herein can include the perforation features, adhesive/co-adhesive elements, ribs, and layering and material options disclosed herein, in various combinations and constructs.

Various methods of forming the biodegradable straws of the present invention can include winding the materials, or otherwise forming portions of the straw, to create pockets of air running generally the length of the straw to assist in the biodegradation process. For example, one or more of the materials that make up the straw can be narrower than others, thereby leaving a gap between wraps, or an air pocket on each side of reinforcement ribs (e.g., that is not full of adhesive) to allow fluids (e.g., air or liquid) to run or be present between the material wraps.

The present invention may be embodied in other specific forms without departing from the spirit or essential attributes thereof, and it is, therefore, desired that the present embodiment be considered in all respects as illustrative and not restrictive. Similarly, the above-described methods and techniques for forming the present invention are illustrative processes and are not intended to limit the methods of manufacturing/forming the present invention to those specifically defined herein. A myriad of various unspecified steps and procedures can be performed to create or form the inventive drinking straws. Further, features and aspects of the various embodiments described herein can be combined to form additional embodiments within the scope of the invention even if such combination is not specifically described herein.

What is claimed is:

1. A drinking straw, comprising:
at least one outer film layer constructed at least in part of a first biopolymer material;
at least one central layer constructed at least in part of a fiber-based material; and
at least one inner layer constructed at least in part of a second biopolymer material, wherein the at least one outer film layer, the at least one central layer, and the at least one inner layer are would to facilitate biodegradability.

2. The straw of claim 1, wherein at least one of the first and second biopolymer materials include a Poly-lactic-acid material.

3. The straw of claim 1, wherein the first and second biopolymer materials include a Poly-lactic-acid material.

4. The straw of claim 1, wherein at least one of the at least one outer film layer or the at least one inner layer includes one or more perforations to facilitate wicking.

5. The straw of claim 1, further including one or more support strips.

6. The straw of claim 5, wherein the one or more support strips are constructed of a biopolymer or fiber-based material.

7. The straw of claim 5, wherein the one or more support strips extend longitudinally along a length of the straw.

8. The straw of claim 5, wherein the one or more support strips are provided in a layer gap.

9. The straw of claim 1, further including an adhering element.

10. A drinking straw, comprising:
a first layer constructed at least in part of a first biopolymer material;
a second layer constructed at least in part of a fiber-based material; and
a third layer constructed at least in part of a second biopolymer material, wherein the fist, second, and third layers provide a construct to promote biodegradability.

11. The straw of claim 10, wherein at least one of the first and third layers include a Poly-lactic-acid material.

12. The straw of claim 10, wherein at least one of first, second, or third layers includes one or more perforations to facilitate wicking.

13. The straw of claim 10, further including one or more support strips.

14. The straw of claim 13, wherein the one or more support strips are constructed of a biopolymer or fiber-based material.

15. The straw of claim 13, wherein the one or more support strips extend longitudinally along a length of the straw.

16. The straw of claim 13, wherein the one or more support strips are provided within a layer gap.

17. The straw of claim 10, further including an adhering element.

18. The straw of claim 10, wherein one of the first and third layers includes a multi-layered laminate construct.

19. The straw of claim 10, wherein the first, second, and third layers are provided on a single material roll to facilitate formation of the straw.

20. The straw of claim 10, further including one or more additional layers of film material.
